(19) United States
(12) Patent Application Publication
(10) Pub. No.: US 2011/0176643 A1
(43) Pub. Date: Jul. 21, 2011

(54) APPARATUS AND METHOD FOR RECEIVING LAYERED DATA THROUGH MULTIPLE MULTICAST CHANNEL

(76) Inventors: Seong-Jun Bae, Daejeon (KR); Seung Seok Hong, Daejeon (KR); Ji Tae Shin, Daejeon (KR); Jeong Ju Yoo, Daejeon (KR); Jin Woo Hong, Daejeon (KR)

(21) Appl. No.: 13/120,546

(22) PCT Filed: Jul. 2, 2009
(86) PCT No.: PCT/KR2009/003565

§ 371 Date: Mar. 23, 2011

(30) Foreign Application Priority Data
Sep. 23, 2008 (KR) 10-2008-0093226

(51) Int. Cl. H04L 7/00; H04L 27/06

(52) U.S. Cl. 375/340; 375/371

(57) ABSTRACT

Disclosed are an apparatus and a method for receiving layered data transmitted over a multiple multicast channel. The layered data receiving method includes receiving the data including a count number, arranging the received data in an order of reception and storing in a jitter buffer, rearranging the data in an order of the count number and storing in a data buffer.

### TECHNICAL FIELD

The present invention relates to an apparatus and method of receiving layered data transmitted over a multiple multicast channel, and more particularly, to an apparatus and method of receiving layered data, the method and apparatus rearranging data received over a multiple multicast channel according to a transmitting order of the data.

### BACKGROUND ART

Multicasting is a method of transmitting information to a plurality of clients from a single server. In the multicasting, a method for rearranging a sequence with respect to received data rearranges the received data using a sequence number in a header of a transmission data.

However, since the sequence number may not be used in multicasting of layered digital video data, a conventional sequence number rearranging method may not be used. This is because a server generates the layered digital video data in group units and separately generates the sequence number for each group.

Since the sequence number of the received data is generated in the group units, it is difficult for a client to rearrange the sequence of the data between groups. Accordingly, if an enhancement layer generated based on a base layer is arranged before the base layer, when the enhancement layer is decoded, there may be a problem that the client may not decode the enhancement layer since the client cannot use the base layer.

Accordingly, with respect to layered digital video data, an apparatus and method for rearranging received data according to a transmitting order of data for convenience of decoding is required.

### DISCLOSURE OF INVENTION

### Technical Goals

An aspect of the present invention provides an apparatus and method of receiving layered data, which enables data to be sequentially decoded through rearranging the data received over a multicast channel according to a transmitting order of the data.

### Technical Solutions

According to an aspect of the present invention, there is provided an apparatus of receiving layered data transmitted over an multiple multicast channel, the apparatus including a jitter buffer to store data after arranging the data including a count number in an order of reception, and rearranging unit to rearrange the data in an order of the count number in a data buffer.

According to an aspect of the present invention, there is provided a method of receiving layered data transmitted over an multiple multicast channel, the method including receiving the data including a count number, arranging the received data in an order of reception and storing in a jitter buffer, rearranging the data in an order of the count number and storing in a data buffer.

### BRIEF DESCRIPTION OF DRAWINGS

FIG. 1 is a block diagram illustrating a configuration of a transmission device for layered data transmitted over a multiple multicast channel;

FIG. 2 is a block diagram illustrating a configuration of a reception device for layered data transmitted over a multiple multicast channel; and

FIG. 3 is a flowchart illustrating a method for receiving layered data transmitted over a multiple multicast channel.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

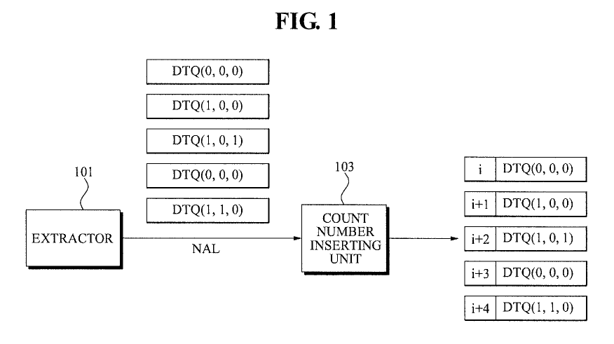

FIG. 1 is a block diagram illustrating a configuration of a transmission device for layered data transmitted over a multiple multicast channel.

Referring to FIG. 1, the transmission device for the layered data transmitted over the multiple multicast channel includes a extractor 101 and a count number inserter 103.

The extractor 101 divides the layered data for each layer. Here, the divided data may be a Network Abstraction Layer (NAL) unit.

The count number inserter 103 inserts a count number to the divided data for each layer. In this instance, the count number inserter 103 inserts a respectively different count number to a header of each NAL unit. The count number inserter 103 classifies data including the count number into each group and transmits the data over the multiple multicast channel.

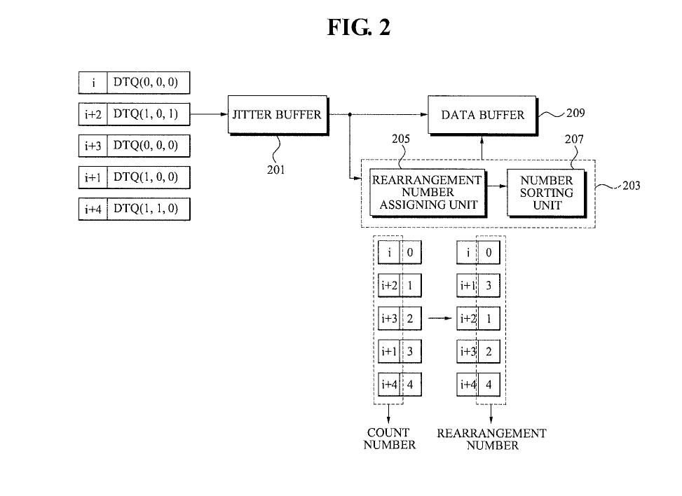

FIG. 2 is a block diagram illustrating a configuration of a reception device for layered data transmitted over a multiple multicast channel.

Referring to FIG. 2, the reception device for the layered data transmitted over the multiple multicast channel includes a jitter buffer 201, rearrangement unit 203, and data buffer 209.

The jitter buffer 201 receives the data including a count number, arranges the data in an order of reception, and stores the data.

The rearranging unit 203 rearranges the data in an order of the count number and stores the data in the data buffer 209.

Particularly, the rearranging unit 203 includes a rearrangement number assigning unit 205 and a number sorting unit 207.

The rearranging number assigning unit 205 assigns a rearrangement number to the count number according to a sequence of the count number in the jitter buffer 201. For example, the rearrangement number assigning unit may respectively assign 0, 1, 2, 3, and 4 to count numbers i, i+2, i+3, i+1, and i+4. Here, the rearrangement number corresponds to each count number and represents a storing order of each corresponding count number in the jitter buffer 201. Also, the rearrangement number may indicate where the corresponding count number is stored in the jitter buffer 201. Accordingly, the rearrangement number 0 indicates that the count number i corresponding to the rearrangement number 0 is stored in a 0^{th} location of the jitter buffer 201, and the rearrangement number 1 may indicate that the count number i+2 corresponding to the rearrangement number 1 is stored in a 1^{st} location of the jitter buffer 201.

The number sorting unit 207 arranges the count number and the rearrangement number based on the count number. For example, the number sorting unit 207 rearranges the count numbers as count numbers i, i+1, i+2, i+3, and i+4 in an order of the count number and also rearranges each rearrangement number corresponding to each count number. That is, the rearrangement number corresponding to the count numbers i, i+2, i+3, i+1, and i+4 may be rearranged as 0, 3, 1, 2, and 4. In this instance, the number sorting unit may perform a bubblesort when rearranging the count number.

The number sorting unit 207 sequentially stores, in a data buffer 209, data including the count number using the rearrangement number in an order of the rearranged count number. In this instance, the number sorting unit 207 may store, in the data buffer 209, data excluding the count number from among the data stored in the jitter buffer 201.

For example, the number sorting unit 207 refers to a location in the jitter buffer 201 indicated by the rearrangement number 0 corresponding to the count number i and stores, in the data buffer 209, data DTQ (0, 0, 0) stored in a 0^{th} location. Also, the number sorting unit 207 refers a location in the jitter buffer 201 indicated by the rearrangement number 3 corresponding to the count number i+1 and stores, in the data buffer 209, data (1, 0, 0) stored in a 3^{rd} location.

Also, the rearranging unit 203 may store a maximum count number in a count number storing unit (not illustrated) from among count numbers included in the data. This may be to verify data received late due to multicasting.

The rearranging unit 203 may store, in the data buffer 209, only data including a count number greater than the maximum count number stored in the count number storing unit. Conversely, the rearranging unit 203 may not store data including count number less than the maximum count number in the data buffer 209, since the data including the count number less than the maximum count number may be redundantly received or the data may be invalid data, such as data not proper to a sequence, and the like.

The data reception device for layered data transmitted over the multiple multicast channel according to an example embodiment of the present invention may simply solve a problem of a sequence rearrangement of data occurring in multicasting with respect to the layered data. Accordingly, it may support decoding the layered data to be easily performed.

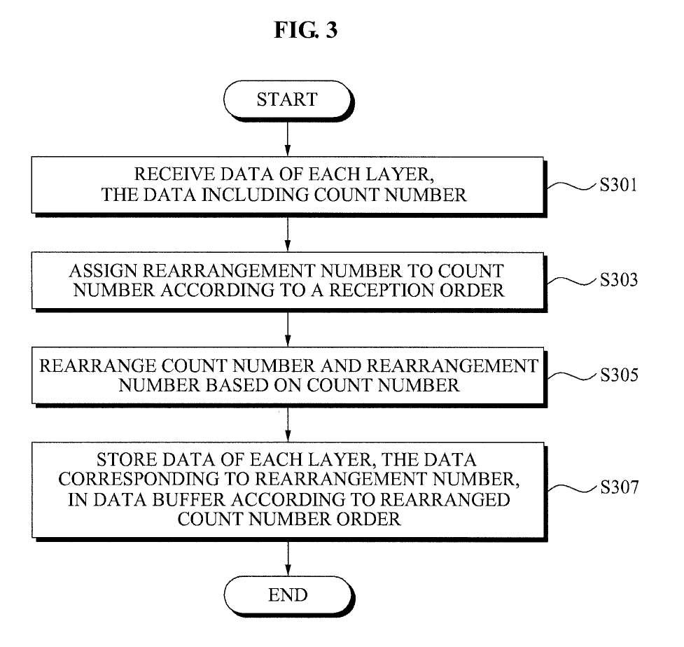

FIG. 3 is a flowchart illustrating a method for receiving layered data transmitted over a multiple multicast channel.

Referring to FIG. 3, a reception device for layered data transmitted over the multiple multicast channel receives data including a count number in operation S301.

Particularly, the reception device for the layered data may receive data respectively having a different count number, arranges the data in an order of reception and store the data in the jitter buffer.

Subsequently, the reception device for layered data assigns a rearrangement number to the count number in an order of the reception in operation S303.

That is, the reception device of the layered data assigns the rearrangement number to the count number according a sequence of the count number stored in the jitter buffer. For example, the reception device for layered data may respectively assign 0, 1, 2, 3, and 4 to count numbers i, i+2, i+3, and i+4.

Subsequently, the reception device for the layered data rearranges the count number and the rearrange number based on the count number in operation S305.

Specifically, the reception device for the layered data sequentially rearranges the count number, and also rearranges the rearrange number corresponding to the count number. In this instance, a bubblesort may be performed, when the count number is rearranged.

For example, the reception device for the layered data rearranges arranged count number i, i+2, i+3, i+1, and i+4 according to a sequence of the count number i, i+1, i+2, i+3, and i+4 and also rearranges the arranged rearrangement number 0, 1, 2, 3, and 4 as 0, 3, 1, 2, and 4.

Here, the reception device for the layered data may store, in a count number storing unit, a maximum count number from among count numbers included in data.

Subsequently, the reception device for the layered data store, in a data buffer, data corresponding to the rearrangement number in an order of rearranged count number in operation S307.

Specifically, the reception device for the layered data refers to a location in the jitter buffer indicated by a rearrangement number 0 corresponding to a count number i and stores, in the data buffer, data DTQ (0, 0, 0) stored in a 0^{th} location.

In this instance, the reception device for layered data compares the count number included in the data with the maximum count number included in the count number storing unit, and store only valid data in the data buffer. Here, invalid data is data including a count number less than the maximum count number, which may be redundantly received or not proper to a sequence.

Accordingly, the reception device for the layered data stores data including a count number greater than the maximum count number in the data buffer, and does not store data including the count number less than the maximum count number in the data buffer, thereby storing only valid data in the data buffer. Subsequently, the reception device for the layered data may easily perform decoding with respect to rearranged data.

The reception device for the layered data may easily perform rearrangement with respect to received data according to a transmitting order of the data using the count number and rearrangement data. According to an example embodiment of the present invention, an apparatus and method for receiving layered data transmitted over a multiple multicast channel may rearrange data received over the multiple multicast channel according to a transmitting order of the data through using a count number and rearrangement number.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of receiving layered data, the method comprising:
receiving the data including a count number;
arranging the received data in an order of reception and storing in a jitter buffer;
rearranging the data in an order of the count number and storing in a data buffer.

2. The method of claim 1, wherein the rearranging of the data comprises:
assigning a rearrangement number to the count number according to a sequence of the count number in the jitter buffer;
rearranging the count number and the rearrangement number based on the count number; and
storing the data corresponding to a location of the rearrangement number of the jitter buffer in the data buffer in an order of the rearranged count number.

3. The method of claim 2, wherein the count number and the rearrangement number are rearranged through a bubblesort based on the count number.

4. The method of claim 1, further comprising:
storing a maximum count number from among count numbers included in the data in a count buffer;
receiving different data including a count number; and
storing, in the data buffer, data including a count number greater than the maximum count number after comparing the maximum count number with the count numbers of the different data.

5. An apparatus of receiving layer structured data, the apparatus comprising:
a jitter buffer to store data after arranging the data including a count number in an order of reception; and
rearranging unit to rearrange the data in an order of the count number in a data buffer.

6. The apparatus of claim 5, wherein the rearranging unit comprises:
a rearrangement number assigning unit to assign a rearrangement number to the count number according to a sequence of the count number in the jitter buffer; and
a number sorting unit to rearrange the count number and the rearrangement number base on the count number.

7. The apparatus of claim 6, wherein the number sorting unit stores the data in the data buffer using the rearrangement number in an order of the rearranged count number.
